(19) United States
(12) Patent Application Publication
(10) Pub. No.: US 2023/0114782 A1
(43) Pub. Date: Apr. 13, 2023

(54) SOFT HANDLE COMPOSITION

(71) Applicant: RUDOLF GMBH, Geretsried (DE)

(72) Inventors: Rainer HAYESSEN, Geretsried (DE); Ludwig HUBER, Geretsried (DE); Dirk SIELEMANN, Wolfratshausen (DE); Gunther DUSCHEK, Benediktbeuern (DE)

(21) Appl. No.: 17/963,517

(22) Filed: Oct. 11, 2022

(30) Foreign Application Priority Data
Oct. 12, 2021 (EP) 21 202 211.5

(51) Int. Cl. C08L 83/04; D06M 15/643

(52) U.S. Cl. CPC C08L 83/04; D06M 15/6436; C08L 2203/12

(57) ABSTRACT

The present invention relates to a composition which can in particular be used as a soft handle composition in the finishing of textiles, comprising at least one quaternary ammonium silane, an organopolysiloxane compound having a dielectric constant of 2.90-10.0, optionally an emulsifier, water and optionally an organic solvent. The invention further relates to a method for preparing the composition according to the present invention, a use of the composition according to the present invention for finishing a textile, a method for finishing a textile, and a product that is obtained by the method according to the present invention.

### CROSS-REFERENCE TO RELATED APPLICATION

This application claims the priority under 35 U.S.C. § 119(a) of Europe Application No. EP 21 202 211.5 filed Oct. 12, 2021, the disclosure of which is expressly incorporated by reference herein in its entirety.

### SUBJECT-MATTER OF THE INVENTION

The present invention relates to a composition which can be used in particular as a soft handle composition in the finishing of textiles, comprising at least one quaternary ammonium silane, an organopolysiloxane compound having a dielectric constant of 2.90-10.0, optionally an emulsifier, water and optionally an organic solvent. The present invention further relates to a process for preparing the composition according to the present invention. In addition, the present invention relates to a use of the composition according to the present invention for finishing a textile, a process for finishing a textile, and a product obtainable by this process.

### PRIOR ART

Organopolysiloxanes can be used as textile finishing agents to produce a soft handle in textiles treated with them. Organopolysiloxanes that can be used in the form of aqueous microemulsions are preferred. A soft handle effect is achieved, for example, with amino group-containing organopolysiloxanes, where the amino groups are present in the form of aminoethylaminopropyl groups in the side chain. In this case, a particular affinity of the soft handle agent to the fiber surface of the textile substrate is achieved, which causes a good soft handle.

WO 2015/040171 A1 describes polysiloxanes with quaternized heterocyclic groups in the side chain for finishing textiles. The compounds are characterized by an excellent soft handle.

EP 1 560 972 A1 discloses preparations comprising partially quaternized, amino-functional organopolysiloxanes and their use in aqueous systems on textile substrates. Here, the quaternary ammonium groups are terminally positioned in the α,ω-position on the polysiloxane backbone and the amino-functional groups are laterally positioned.

EP 1 576 056 A1 describes highly concentrated, self-emulsifying preparations containing organopolysiloxanes and alkylammonium compounds and their use in aqueous systems on textile substrates.

It has been shown that bacteria and other microorganisms multiply very rapidly in the presence of moisture and perspiration in textiles that are preferably intended to have a soft handle and are in close body contact, such as towels or bathrobes, but also in sportswear and medical textiles.

Colonization by microorganisms, and thus the decomposition of products and materials often associated with it, can be prevented by antimicrobial agents. These agents act by inhibiting the growth of or killing bacteria, fungi, viruses, and/or algae.

Quaternary ammonium organosilanes are used as preservatives in liquid compositions such as cosmetics, textile auxiliaries, and products for the oil, gas, paper, leather, and food industries because of their biocidal activity. They can also be used directly to protect solid surfaces such as wood, textiles, leather, stone, concrete, plastics, etc. They are also frequently used as a component of coating compositions to protect the coatings produced with them from infestation by microorganisms.

U.S. Pat. No. 4,631,273 A describes aqueous emulsions of quaternary ammonium organosilanes for antimicrobial coating.

EP 0 552 874 A1 discloses compositions comprising an alkyltrialkoxysilane as biocidal active ingredient in combination with a water-soluble silane coupling agent and an aqueous emulsion of a hydroxy endblocked polydiorganosiloxane. The composition polymerizes and leaves a hydrophobic elastomeric film upon drying.

EP 0 354 569 A1 describes water-soluble compositions comprising quaternary ammonium organosilanes for antimicrobial treatment of textiles or skin.

The importance of antimicrobially treated textiles has increased significantly in recent years. Nowadays, high demands are made on hygiene not only in the consumer sector but also in the professional occupational safety sector, for example in the healthcare sector. Microorganisms can be distributed via textile materials, so that, for example, clothing in hospitals and care facilities can pose a potential hazard when in use. By finishing with antimicrobial agents, the contamination of textiles with undesirable microorganisms can be effectively prevented, thus reducing or eliminating a transmission path.

EP 0 279 623 describes silane microemulsions suitable for antimicrobial coating of a variety of surfaces, in particular textile surfaces.

EP 2 102 408 A1 discloses methods for the antimicrobial, wash-resistant finishing of textiles and fibers. Quaternary ammonium silanes are applied to the substrates for this purpose with an organic primer component that increases the hydrophobicity of the textiles and fibers.

EP 2 099 302 A1 provides compositions comprising a quaternary ammonium organosilane compound and a metal salt component for antimicrobial finishing of textiles.

However, the quaternary ammonium silane compounds used in the prior art deteriorate the soft handle of textiles. Therefore, there is a great need to provide a combination of soft handle agents and antimicrobial agents.

EP 0 415 540 A1 describes antimicrobial agents in combination with a soft handle agent for use as a hygiene rinse. The soft handle agent is preferably selected from quaternary monoammonium compounds having C₁₂-C₂₀ or C₁₈-C₂₄ alkyl chains, quaternary imidazole and polyammonium compounds, polyamine and polyalkyleneimine salts.

WO 2018/085564 describes compositions for textile treatment comprising an antimicrobial agent and a soft handle agent, preferably a fatty acid amide.

However, these combinations of soft handle agent and antimicrobial agent have several problems. First, antimicrobial quaternary ammonium silanes deteriorate the handle of the textile. Secondly, organopolysiloxane compounds have been shown to reduce the antimicrobial effect of quaternary ammonium organosilane compounds.

It is therefore an object of the present invention to provide a composition that provides both improved soft handle and wash-permanent antimicrobial and/or antiviral activity.

Surprisingly, compositions comprising at least one quaternary ammonium silane and an organopolysiloxane compound having a dielectric constant of 2.90-10.0 were found to accomplish this task. On textiles, the compositions according to the present invention lead to an improved soft handle and, at the same time, to wash-permanent antimicrobial/antiviral efficacy. In addition, the finished textiles are characterized by improved absorbency.

### DETAILED DESCRIPTION OF THE INVENTION

The present invention relates to a composition comprising
(I) (I) at least one quaternary ammonium silane represented by the following formula (1)

X₄₋ₙSi(—R—NR¹R²R³)ₙ⁺Y⁻ Formula (1)

wherein

X is independently an alkoxy residue having 1 to 6 carbon atoms, an alkoxyalkoxy residue having 2 to 8 carbon atoms, or an alkyl residue having 1 to 6 carbon atoms,

Y⁻ is an acid anion,

n is an integer selected from 1, 2 or 3,

R is a divalent hydrocarbon residue having 1 to 6 carbon atoms,

R¹ is a saturated or unsaturated, linear or branched hydrocarbon residue having 8 to 22 carbon atoms,

R² is a saturated or unsaturated, linear or branched hydrocarbon residue having 1 to 22 carbon atoms,

R³ is a saturated or unsaturated, linear or branched hydrocarbon residue having 1 to 22 carbon atoms;
(II) an organopolysiloxane compound having at least one functional group selected from a quaternary ammonium group, an amino group, an amido group and a polyalkylene oxide group,
   wherein the dielectric constant of the component (II) is 2.90-10.0 as measured at 25° C. and 10 kHz;
(III) optionally an emulsifier;
(IV) water; and
(V) optionally an organic solvent.

The composition according to the present invention comprises (1) at least one compound of formula (1)

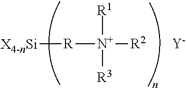

X is independently an alkoxy residue having 1 to 6 carbon atoms, an alkoxyalkoxy residue having 2 to 8 carbon atoms, or an alkyl residue having 1 to 6 carbon atoms. In a preferred embodiment, X is an alkoxy residue having 1 to 6 carbon atoms, preferably selected from methoxy or ethoxy, especially methoxy.
n is an integer selected from 1, 2 or 3. In a preferred embodiment, n is an integer selected from 1 or 2, and preferably 1.
R is a divalent hydrocarbon residue having 1 to 6 carbon atoms. In a preferred embodiment, R is a divalent alkyl group having 1 to 6 carbon atoms, preferably selected from ethyl or propyl, more preferably propyl.
R¹ is a saturated or unsaturated, linear or branched hydrocarbon residue having 8 to 22 carbon atoms. In a preferred embodiment, R¹ is a linear or branched alkyl residue having 8 to 22 carbon atoms, preferably selected from dodecyl, tetradecyl, hexadecyl or octadecyl, more preferably tetradecyl, hexadecyl or octadecyl.
R² is a saturated or unsaturated, linear or branched hydrocarbon residue having 1 to 22 carbon atoms. In a preferred embodiment, R² is a linear or branched alkyl residue having 1 to 22 carbon atoms, in particular 1-10 carbon atoms. In particular, R² is methyl or ethyl, preferably methyl.
R³ is a saturated or unsaturated, linear or branched hydrocarbon residue having 1 to 22 carbon atoms. In a preferred embodiment, R³ is a linear or branched alkyl residue having 1 to 22 carbon atoms. In particular 1-10 carbon atoms. In particular, R³ is methyl or ethyl, more preferably methyl.

In a preferred embodiment, both R² and R³ are an alkyl residue having 1 to 22 carbon atoms, in particular 1-10 carbon atoms. Preferably, R² and R³ are each selected from methyl and ethyl.

R² and R³ may be different hydrocarbon residues having 1 to 22 carbon atoms. In a preferred embodiment, R² and R³ are ethyl. In a particularly preferred embodiment, R² and R³ are methyl.
Y⁻ is an acid anion. An acid anion according to the present invention is a negatively charged molecule or atom obtainable by dissociation of an acid molecule. In particular, the acid anion Y⁻ has simple negative charge. Preferably, Y⁻ is selected from chloride, bromide, iodide, methosulfate or tosylate.

In a preferred embodiment:

X is an alkoxy residue having 1 to 6 carbon atoms,
n is an integer selected from 1 or 2,
R is a divalent alkyl group having 1 to 6 carbon atoms,
R¹ is a linear or branched alkyl residue having from 8 to 22 carbon atoms,
R² is a linear or branched alkyl residue having 1 to 22 carbon atoms,
R³ is a linear or branched alkyl residue having 1 to 22 carbon atoms, and
Y⁻ is chloride, bromide, iodide, methosulfate or tosylate.

In a particularly preferred embodiment:

X is selected from methoxy or ethoxy, especially methoxy,
n is an integer selected from 1 or 2 and preferably 1,
R is ethyl or propyl, particularly preferably propyl,
R¹ is selected from dodecyl, tetradecyl, hexadecyl or octadecyl, preferably tetradecyl, hexadecyl or octadecyl. and
R² is methyl or ethyl, preferably methyl,
R³ is methyl or ethyl, preferably methyl, and
Y⁻ is selected from chloride or bromide.

In particular, the at least one quaternary ammonium silane of formula (1) may be selected from:

(CH₃O)₃Si(CH₂)₃N⁺(CH)₂C₁₈H₃₇Cl⁻
(CH₃O)₃Si(CH₂)₃N⁺(CH₃)₂C₁₈H₃₇Br⁻
(CH₃O)₃Si(CH₂)₃N⁺(C₁₀H₂₁)₂CH₃Cl⁻
(CH₃O)₃Si(CH₂)₃N⁺(C₁₀H₂₁)₂CH₃Br⁻
(C₂H₅O)₃Si(CH₂)₃N⁺(CH₃)₂C₁₈H₃₇Cl⁻
(CH₃)₃Si(CH₂)₃N⁺(CH₃)₂C₁₂H₂₅Cl⁻
(CH₃)₃Si(CH₂)₃N⁺(C₁₀H₂₁)₂CH₃Cl⁻
(CH₃)₃Si(CH₂)₃N⁺(CH₃)₂C₁₈H₃₇Cl⁻

In a particularly preferred embodiment, component (I) is 3-(trimethyloxysilyl)propyldimethyloctadecylammonium chloride.

Component (I) has an antimicrobial and/or antiviral activity. An antimicrobial effect means that component (I) reduces or inhibits the growth of microorganisms, such as bacteria, fungi, algae and/or yeasts, or kills or inactivates them. An antiviral effect means that component (I) causes the inactivation of viruses. In particular, component (I) is present in the composition according to the present invention in such an amount that the composition has an antimicrobial and/or antiviral effect. An antibacterial effect can be determined according to ISO 20743. An antiviral effect can be determined according to ISO 18184.

The content of component (I) may be 1-25 wt. %, preferably 1-15 wt. %, particularly preferably 1-10 wt. % based on the total weight of the composition. In a preferred embodiment, the composition according to the present invention comprises 1-25 wt. %, preferably 1-15 wt. %, particularly preferably 1-10 wt. % 3-(trimethyloxysilyl)propyldimethykoctadecylammonium chloride based on the total weight of the composition.

The at least one ammonium silane is particularly a reactive alkoxysilane, such as a reactive methoxysilane. A reactive alkoxysilane is a silane compound whose alkoxy groups can partially hydrolyze and/or condense in contact with water. Component (I) may thus be present in the composition according to the present invention partially hydrolyzed and/or condensed. Remaining non-hydrolyzed and/or condensed alkoxy groups, when the composition according to the present invention is applied to a substrate such as a textile, may react with the substrate and/or other ammonium silane molecules having non-hydrolyzed and/or condensed alkoxy groups to form a polymer network on the substrate surface. The quaternary ammonium group of the silane is not involved in this hydrolysis or condensation reaction and is responsible for the antimicrobial and/or antiviral activity of component (I) against e.g. bacteria, fungus, algae, and viruses.

Ammonium silane compounds corresponding to component (I) can be prepared, for example, by reacting a chloroalkylsilane with tertiary amines. Particularly suitable is the reaction of chloropropyltrimethoxysilane with dimethyttetradecylamine, dimethylhexadecylamine or dimethyloctadecylamine.

The composition according to the present invention further comprises (II) an organopolysiloxane compound having at least one functional group selected from a quaternary ammonium group, an amino group, an amido group and a polyalkylene oxide group.

The dielectric constant of component (II) is 2.90-10.0, measured at 25° C. and 10 kHz on the pure substance, i.e. without solvent or the like, following DIN EN 60247 (cf. Nihon Rufuto Co., Ltd., Liquid Dielectric Constant Meter Model 871, Operation Manual Version 1.0 2008). In a preferred embodiment, the dielectric constant of component (II) is 2.90-6.50, more preferably 2.90-5.00, in particular 3.00-5.80, measured at 25° C. and 10 kHz on the pure substance.

The content of component (I1) in the composition according to the present invention may be 1-50 wt. %, preferably 5-30 wt. %, more preferably 10-20 wt. % based on the total weight of the composition.

A weight ratio of component (I) to component (II) in the composition according to the present invention can be 1:50 to 25:1, preferably 1:30 to 3:1, more preferably 1:20 to 1:1.

Component (II) is in particular a polyalkylsiloxane and preferably a polydimethylsiloxane having at least one functional group selected from a quaternary ammonium group, an amino group, an amido group and a polyalkylene oxide group.

Component (II) preferably has at least one quaternary ammonium group and/or at least one amino group. Preferably, component (II) has
at least one quaternary ammonium group,
at least one quaternary ammonium and polyalkylene oxide group,
at least one amino and polyalkylene oxide group,
at least one quaternary ammonium, amino and polyalkylene oxide group,
at least one amino and amido group,
at least one amino, amido, and polyalkylene oxide group, or
at least one quaternary ammonium, amino, amido, and polyalkylene oxide group.

The at least one functional group may be present laterally in a lateral position to the polysiloxane backbone, terminally at the end of the polysiloxane backbone and/or in the polysiloxane backbone of component (II). Functionalization of organopolysiloxane compounds can be accomplished via methods known to those skilled in the art. These include, for example, hydrosilylation reactions, addition reactions to epoxy group-bearing organopolysiloxanes, reaction reactions with isocyanate compounds, and quaternization reactions.

Suitable quaternary ammonium groups have, for example, the following structure

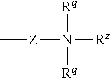

wherein R^{q} may independently be hydrogen, an alkyl, aryl, aralkyl residue or a cycloaliphatic residue having 1-20 carbon atoms, optionally comprising one or more heteroatoms and/or one or more functional groups such as one or more hydroxy, amido, urethane, urea and/or ester groups;
Z can be a divalent straight chain, cyclic or branched hydrocarbon residue, which may be interrupted by

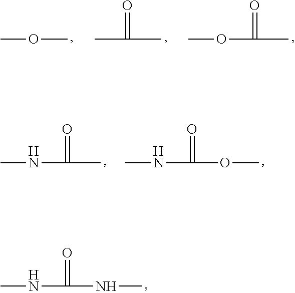

and substituted with —OH; and
R^{z} is either equal to R^{q}, or optionally can be equal to —Z—, provided that the quaternary ammonium group is located in the polymer backbone.

Suitable amino groups may be primary, secondary and/or tertiary amino groups. Particularly suitable are aminopropyl, aminoethylaminopropyl, aminophenyl, phenylaminopropyl, aminoethylaminoisobutyl, diethylenetriaminopropyl, vinylbenzylethylenediaminopropyl, benzylethylenediaminopropyl and addition products of primary or secondary amines to epoxy-modified polysiloxanes.

Suitable polyalkylene oxide groups are obtained, for example, by addition of ethylene oxide, propylene oxide, and/or tetramethylene oxide to alcohols. The alkylene oxide groups may be present in block-like or random distribution. The linkage to the polysiloxane can thereby take place, for example, via a hydrosilylation, epoxy ring-opening, esterification, amidation and/or isocyanate reaction.

The content of polyalkylene oxide groups in component (II) can be 0-60 wt. %, preferably 0-40 wt. %, particularly preferably 0-20 wt. % based on the total weight of component (II).

Suitable amido groups can be obtained, for example, by reacting the above-mentioned primary and secondary amines with carboxylic acid derivatives. Examples of carboxylic acid derivatives are carboxylic acid esters, such as methyl or ethyl carboxylic acid esters, or cyclic lactones, such as butyrolactone, carboxylic acid anhydrides, such as glacial anhydride, or carboxylic acid halides, such as carboxylic acid chlorides or carboxylic acid bromides, or carboxylic acid derivatives activated with dicyclohexyl carbodiimide (DCC), so-called O-acyl isoureas or other active esters.

The nitrogen content in component (II) may be 0.05-2 wt. %, preferably 0.10-1.5 wt. %, particularly preferably 0.10-1.0 wt. %, taking into account the amino, amido and ammonium groups that may be present. The nitrogen content can be determined, for example, by the Kjeldahl method.

Component (II) may have a molecular weight of 500-50000 g/mol, preferably 1000-20000, particularly preferably 1500-10000 g/mol.

Preferably, component (II) is a soft handle agent. A soft handle agent in the sense of the present invention is a compound which imparts a soft handle to a substrate, in particular a textile, finished therewith.

Furthermore, in the absorbency test according to AATCC 79, component (II) can provide a sink-in time on cotton of 0.1-30 sec, preferably 0.1-10 sec, particularly preferably 0.1-3 sec. Absorbency is measured by completely dissolving the organopolysiloxane in a solvent or solvent mixture. The solvent may be water, methanol, ethanol, isopropanol, acetone, methyl ethyl ketone, methyl propyl ketone, ethyl acetate, isoproyl acetate, and/or hydrocarbon solvent. The concentration of the solution is adjusted to 1.0% solids. Then, 100 ml of each of these solutions is poured into a beaker and the cotton fabric (200±5×200±5 mm) standardized according to AATCC 79 is completely immersed. The treated fabric is then passed through two squeeze rollers in a padder to remove excess solution. The squeezing pressure is selected to achieve a liquor pick-up of approx. 80%. The finished cotton samples are then first dried in a fume hood for 24 h at room temperature and then post-dried for 1 min at 140° C. on a laboratory stenter frame dryer.

To assess the absorbency, 201 of fully demineralized water is dropped onto the textile from a defined height of 40 mm. The time until the drop has completely sunk in is then measured.

The assessment shown in Table 1 was applied for the characterization of compounds with respect to their influence on absorbency according to the above test.

TABLE 1
Classification of compounds
according to their absorbency.

| Absorbency | Sink-in time | |
|---|---|---|
| very high | ≤3 | sec |
| high | >3-30 | sec |
| neutral | >30-70 | sec |
| low | >70-120 | sec |
| very low | >120 | sec |

Preferably, component (II) causes a high absorbency, in particular a very high absorbency, of a substrate treated therewith determined according to AATCC 79 and Table 1 above.

Component (II) is preferably present in the composition according to the present invention in such an amount that the composition causes a high absorbency, in particular a very high absorbency, of a substrate treated therewith determined according to AATCC 79 and Table 1 above.

The composition according to the present invention may further comprise (III) an emulsifier. For example, component (III) may comprise a cationic, amphoteric or nonionic emulsifier. Preferably, component (III) comprises at least one cationic emulsifier and/or an ethoxylation product of an aliphatic alcohol having 6 to 22 carbon atoms and having an ethylene oxide content of up to 50 moles.

In one embodiment, component (III) comprises an alkoxylation product, in particular an ethoxylate or propoxylate, of an aliphatic alcohol having 6 to 22 carbon atoms, preferably 8 to 16 carbon atoms. Suitable alcohols may be saturated, linear or branched, preferably branched, and may be used alone or in admixture. In particular, component (II) comprises an alkoxylation product, especially an ethoxylate or propoxylate, of a branched aliphatic alcohol. A suitable alkoxylation content may be up to 50 moles, preferably 2 to 50 moles, in particular 3 to 15 moles.

Of particular advantage in terms of low foam development in the application liquors are alkoxylation products of an aliphatic alcohol with 6 to 22 carbon atoms if alkylene oxide residues of ethylene oxide and 1,2-propylene oxide are present in random distribution and preferably in block-like distribution. Non-ionic emulsifiers from the group of ethoxylated, branched aliphatic alcohols are particularly preferred due to their favorable overall properties. In particular, component (III) preferably comprises an ethoxylate of 2,6,8-trimethyl-4-nonanol, isodecyl alcohol or isotridecyl alcohol with an ethylene oxide content of 2 to 50 mol, in particular 3 to 15 mol.

In one embodiment, component (III) comprises at least one cationic emulsifier. Suitable cationic emulsifiers are quaternary ammonium salts, preferably di-(C₁₀-C₂₄)-alkyldimethylammonium chloride, (C₁₀-C₂₄)-alkyldimethylethylammonium chloride or- bromide, (C₁₀-C₂₄)-alkyltrimethylammonium chloride or- bromide, (C₁₀-C₂₄)-alkyl dimethyl benzyl ammonium chloride, N—(C₁₀-C₁₈)-alkyl pyridinium chloride or bromide, N—(C₁₂-C₁₈)-isoquinolinium chloride, bromide or monoalkyl sulfate, N—(C₁₂-C₁₈)-alkyl N-methyl ammonium morpholinium chloride, bromide or monoalkyl sulfate, N—(C₁₂-C₁₈)-alkyl-N-ethyl-ammounium morpholinium chloride, bromide or monoalkyl sulfate, N—(C₁₂-C₁₈)-alkylmethyl polyoxyethylene ammonium chloride, bromide or monoalkyl sulfate, a salt of a primary, secondary or tertiary fatty amine having 8 to 24 carbon atoms, with an organic acid such as acetic acid, lactic acid, glycolic acid or citric acid, or an inorganic acid such as hydrochloric acid, sulfuric acid and phosphoric acid, or a mixture thereof.

The content of component (III) may be 0-20 wt. %, preferably 1-15 wt. %, more preferably 2-10 wt. %, based on the total weight of the composition.

Furthermore, the composition (IV) according to the present invention comprises water. The content of water may be up to 98 wt. %, preferably 25-92.5 wt. %, more preferably 49-84 wt. %, based on the total weight of the composition.

The composition according to the present invention may further comprise (V) an organic solvent. Component (V) may also comprise a mixture of the organic solvents described herein. The content of component (V) may be 0-20 wt. %, preferably 1-10 wt. %, particularly preferably 2-6 wt. % based on the total weight of the composition.

Suitable organic solvents are, for example, monofunctional or polyfunctional alcohols, which in particular have 2-10, preferably 2-6, more preferably 2-4 carbon atoms. Monofunctional alcohols comprise one hydroxy group per alcohol molecule. Polyfunctional alcohols comprise at least two, such as two to five hydroxy groups per alcohol molecule. In a preferred embodiment, the organic solvent is methanol, ethanol, isopropanol and/or a dialcohol having 2-10 carbon atoms.

Mono- and diethers, in particular mono- and dialkyl ethers, as well as mono- and diesters, such as alkyl esters, of these dialcohols are also suitable. In one embodiment, component (V) comprises butyl diglycol, 1,2-propylene glycol, dipropylene glycol, dipropylene glycol monomethyl ether, dipropylene glycol monobutyl ether, tipropylene glycol monobutyl ether, or a mixture thereof.

The composition according to the present invention may further comprise (VI) a mono- or polyfunctional carboxylic acid having 1-5 carbon atoms. Monofunctional carboxylic acids comprise one carboxy group per acid molecule. Polyfunctional carboxylic acids comprise at least two carboxy groups, in particular 2 or 3 carboxy groups per acid molecule. In particular, component (VI) is selected from formic acid, acetic acid, propanoic acid, butanoic acid, pentanoic acid, lactic acid, citric acid, maleic acid, fumaric acid, succinic acid, pyruvic acid, polyhydroxycarboxylic acids and mixtures thereof. In a preferred embodiment, component (VI) comprises acetic acid, lactic acid or citric acid.

The content of component (VI) may be 0-10 wt. %, preferably 0.5-5 wt. %, more preferably 1-5 wt. % based on the total weight of the composition.

In one embodiment, the composition according to the present invention comprises:
1-25 wt. %, preferably 1-15 wt. %, particularly preferably 1-10 wt. % of component (I), 1-50 wt. %, preferably 5-30 wt. %, particularly preferably 10-20 wt. % of component (II), and up to 98 wt. %, preferably 25-92.5 wt. %, particularly preferably 49-84 wt. % of water, in each case based on the total weight of the composition.

In a preferred embodiment the composition according to the present invention comprises:
1-25 wt. %, preferably 1-15 wt. %, particularly preferably 1-10 wt. % of component (I), 1-50 wt. %, preferably 5-30 wt. %, particularly preferably 10-20 wt. % of component (II), up to 20 wt. %, preferably 1-15 wt. %, particularly preferably 2-10 wt. % of component (III), up to 98 wt. %, preferably 25-92.5 wt. %, particularly preferably 49-84 wt. % of water, up to 20% by weight, preferably 1-10% by weight, particularly preferably 2-6% by weight, of component (V) and up to 10% by weight, preferably 0.5-5% by weight, particularly preferably 1-5 wt. %, of component (VI), in each case based on the total weight of the composition.

Surprisingly, it was found that the composition according to the present invention imparts both a high antimicrobial/antiviral activity and a high soft handle. In contrast to compositions known in the prior art, which can satisfactorily meet only one of the two requirements, the composition according to the present invention allows soft handle and antimicrobial/antiviral activity to be combined to a high degree.

In addition, the composition exhibits high wash permanence. Even after multiple washings, substrates treated therewith, such as textiles, retain a high antimicrobial/antiviral property or even exhibit an improved antimicrobial/antiviral effect.

In another aspect, the present invention relates to a process for preparing a composition according to the present invention, comprising
a) mixing components (I), (II), optionally (III), optionally (V) and optionally (VI) and
b) optionally adding of (VI) water to the mixture obtained in step a).
   Components (I), (II), (III), (VI), (V) and (VI) are as defined herein.

The preparation according to the present invention can be prepared by emulsification processes known to those skilled in the art. Preferably, the individual components (I), (II), optionally (III), optionally (V) and optionally (VI) are mixed together with stirring in step a). It may be convenient to mix components (I), (II), optionally (II) and optionally (V) with stirring at elevated temperature, i.e. higher than room temperature (20° C.).

Step (a) may be carried out in the presence of a small amount of organic acid (component (VI), for example acetic acid or lactic acid.

A suitable amount of component (VI) may result, for example, in a content of component (VI) in the composition according to the present invention of up to 10 wt. %, preferably 0.5-5 wt. %, more preferably 1-5 wt. % based on the total weight of the composition.

An elevated temperature and/or an addition of component (VI) in step a) may help to bring the polymer (component II) into the form of an emulsion preferably applicable from aqueous medium.

In a further aspect, the present invention relates to a use of the composition according to the present invention for finishing a textile, i.e. a textile substrate. In particular, the composition according to the present invention can be used for antimicrobial and/or antiviral finishing of a textile. For example, the composition according to the present invention is suitable for use in finishing textile substrates in aqueous baths and application liquors.

The textile may be selected from woven fabrics, knitted fabrics, braided fabrics and textile composites of native fibers, such as cotton or wool fibers, but also of synthetic fibers, such as viscose, polyester, polyamide or polyacrylonitrile fibers. When applied to textile substrates, the preparations according to the present invention can also be combined with textile auxiliaries commonly used in the textile industry, such as agents that improve the detangling properties, for example methylol compounds of dihydroxyethylene urea or methylol melamine ethers of different degrees of methylolation.

In another aspect, the present invention relates to a process for finishing a textile comprising
application of the composition according to the present invention to a textile and if necessary, drying the textile thus treated.

The textile may be as defined herein. The application of the composition according to the present invention may be carried out in an amount of 0.2-5 dry wt. %, preferably 1-3 dry wt. % of components (I), (II) and optionally (III) based on the weight of the textile.

Usually, a liquor of the composition according to the present invention is made in the desired concentration by means of a forced application of aqueous medium by padding, spraying, patting, foaming. The liquor uptake may range from 40 to 100%.

Where appropriate, the process may comprise subsequent drying of the treated textile, in particular at a temperature of 80-150° C. In one embodiment, the drying step comprises pre-drying at 80-110° C. followed by heat treatment at 130-150° C. The duration of the heat treatment in each case depends on the temperatures applied and is preferably 1-5 minutes.

In another aspect, the present invention relates to a product obtainable by a finishing process according to the present invention.

It was surprisingly found that the product according to the present invention, i.e. the finished textile, exhibits both a high antimicrobial/antiviral property and a high soft handle. In contrast to textiles known from the prior art, which can satisfactorily meet only one of the two requirements, the composition according to the present invention allows soft handle and antimicrobial/antiviral activity of the finished textile to be combined to a high degree.

In addition, the antimicrobial/antiviral property and soft handle of the product according to the present invention are highly wash-resistant. Even after multiple washings, the finished textiles retain a high antimicrobial/antiviral property or even exhibit an improved antimicrobial/antiviral effect.

### EXAMPLES

The present invention will be explained in more detail with reference to the following examples, although it is not limited thereto.

### Embodiment 1 (AB 1)

### Synthesis Component (II):

N,N-dimethylbutylamine (2.53 g, 25 mmol), a polydimethylsiloxane terminated with allyl glycidyl ether with an average chain length of about 55 repeat units (71.3 g, 25 mmol epoxy), and lactic acid (2.25 g, 25 mmol) were placed in a three-neck flask equipped with a thermometer and KPG stirrer, dissolved in 1,2-propylene glycol (component (V)) (20 g) and stirred for 3 h at 90° C. The epoxy concentration was monitored titrimetrically. A highly viscous clear, colorless liquid was obtained (component (II) and (V)).

### Formulation:

The reaction mixture (component (II) and component (V)) (20 g) was mixed in a beaker with dimethyloctadecyl[3-(trimethoxysilyl)propyl]ammonium chloride (component (I)) (70 wt. % in methanol, 6 g) and a fatty alcohol ethoxylate 10 EO (component (Iii)) (8 g) and acetic acid (component (VI)) (60%; 2 g). demineralized water (70.6 g) was added in small portions within 10 min under stirring until a clear solution was obtained.

### Embodiment 2 (AB 2)

### Synthesis Component (II):

N,N-dimethyloctylamine (3.93 g, 25 mmol), a polydimethylsiloxane terminated with allyl glycidyl ether with an average chain length of about 55 repeat units (71.3 g, 25 mmol epoxy), and lactic acid (2.25 g, 25 mmol) were placed in a three-neck flask equipped with a thermometer and KPG stirrer, dissolved in 1,2-propylene glycol (component (V)) (20 g) and stirred for 3 h at 90° C. The epoxy concentration was monitored titrimetrically. A highly viscous clear, colorless liquid was obtained (component (II) and (V)).

### Formulation:

In the next step, the reaction mixture (component (II) and component (V)) (20 g) was mixed in a beaker with dimethyl octadecyl[3-(trimethoxysilyl)propyl]ammonium chloride (component (I)). (70 wt. % in methanol. 6 g) and a fatty alcohol ethoxylate 10 EO (component (III)) (8 g) and acetic acid (component (VI)) (60%; 2 g). Demineralized water (70.6 g) was added in small portions within 10 min under stirring until a clear solution was obtained.

### Embodiment 3 (AB 3)

### Synthesis Component (II):

N,N-dimethyllaurylamine (5.34 g, 25 mmol), a polydimethylsiloxane terminated with allyl glycidyl ether with an average chain length of about 55 repeat units (71.3 g, 25 mmol epoxy), and lactic acid (2.25 g, 25 mmol) were placed in a three-neck flask equipped with a thermometer and KPG stirrer, dissolved in 1,2-propylene glycol (component (V)) (20 g) and stirred for 3 h at 90° C. The epoxy concentration was monitored titrimetrically. A highly viscous clear, colorless liquid was obtained (component (II) and (V)).

### Formulation:

In the next step, the reaction mixture (component (II) and component (V)) (20 g) was mixed in a beaker with dimethyloctadecyl[3-(trimethoxysilyl)propyl]ammonium chloride (component (I)) (70 wt. % in methanol, 6 g) and a fatty alcohol ethoxylate 10 EO (component (III) (8 g) and acetic acid (component (VI)) (60%; 2 g). Demineralized water (70.6 g) was added in small portions within 10 min under stirring until a clear solution was obtained.

### Embodiment 4 (AB 4)

### Synthesis Component (II):

Stearyldimethylamine (6.75 g, 25 mmol), a polydimethylsiloxane terminated with allyl glycidyl ether with an average chain length of about 55 repeat units (71.3 g, 25 mmol epoxy), and glacial acetic acid (1.5 g, 25 mmol) were placed in a three-neck flask equipped with a thermometer and KPG stirrer, dissolved in 1,2-propylene glycol (component (V)) (20 g) and stirred for 3 h at 90° C. The epoxy concentration was monitored titrimetrically. A highly viscous clear, colorless liquid was obtained (component (II) and (V)).

### Formulation:

In the next step, the reaction mixture (component (II) and component (V) (20 g) was mixed in a beaker with dimethyloctadecyl[3-(trimethoxysilyl)propyl]ammonium chloride (component (I)) (70 wt. % in methanol, 6 g) and a fatty alcohol ethoxylate 10 EO (component (III)) (8 g) and acetic acid (component (VI)) (60%; 2 g). Demineralized water (70.6 g) was added in small portions within 10 min under stirring until a clear solution was obtained.

### Embodiment 5 (AB 5)

### Synthesis Component (II):

The preparation of the ammonium- and polyether-modified organopolysiloxane was carried out by reaction of 199.0 g (0.2 mol epoxy content), α,ω-diepoxypolydimethylsiloxane with 10.0 g (0.1 mol) N-methylpiperazine analogous to DE-OS 1493384 (Example 1). Subsequently, in analogy to U.S. Pat. No. 6,495,727 (Example 1), 56.6 g (0.1 mol) of an isodecyl alcohol having 4 EO units and 4 PO units was added.

### Formulation:

In the next step, the polydimethylsiloxane thus prepared (component (II)) (16 g) was mixed in a beaker with 1,2-propylene glycol (component (V)) (4 g), dimethyloctadecyl[3-(trimethoxysilyl)propyl]ammonium chloride (component (I)) (70 wt. % in methanol, 6 g) and a fatty alcohol ethoxylate 10 EO (component (III)) (8 g) and acetic acid (component (VI)) (60%; 2 g). Demineralized water (70.6 g) was added in small portions within 10 min by stirring until a clear solution was obtained.

### Comparative Embodiment (VB 1)

An aminoethylaminopropyl side chain modified polydimethylsiloxane (20 g) with a dielectric constant of 2.86 was mixed in a beaker with dimethyloctadecyl[3-(trimethoxysilyl)propyl]ammonium chloride (70 wt. % in methanol, 6 g), a fatty alcohol ethoxylate 10 EO (8 g), and acetic acid (60%: 2 g). Demineralized water was added by stirring within 10 minutes until a clear solution was obtained.

TABLE 2
Properties of the compositions obtained in AB1-5 and VB1.

| Example | AB 1 | | AB 2 | | AB 3 | | AB 4 | | AB 5 | | VB 1 | |
|---|---|---|---|---|---|---|---|---|---|---|---|---|
| Dielectric constant | 3.65 | | 3.19 | | 3.05 | | 3.30 | | 5.73 | | 2.86 | |
| Washes | 0 | 5 | 0 | 5 | 0 | 5 | 0 | 5 | 0 | 5 | 0 | 5 |
| Antibacterial activity | 3.21 | 4.02 | 2.87 | 2.76 | 3.52 | 4.50 | 2.94 | 2.52 | 3.13 | 2.65 | 3.86 | 0.71 |
| according to ISO | | | | | | | | | | | | |
| 20743² | | | | | | | | | | | | |

| | | | | | | |
|---|---|---|---|---|---|---|
| Sink-in time [s]³ | 7 | 4 | 15 | 9 | 3 | >300 |
| Sink-in time [s]⁴ | 2 | 1 | 3 | 2 | 1 | 74 |
| Soft handle⁵ | 3.75 | 3.875 | 3.375 | 3.5 | 3.625 | 4 |

¹ Determination was carried out for the pure organopolysiloxanes (component (II)).
²Determination on finished product according to finishing instructions. The product was finished with the formulations according to the embodiments.
³Determination of the sink-in time of the textiles finished with the pure organopolysiloxanes (component (II))
⁴Determination of the sink-in time of the textiles finished with the formulations according to AB1-4
⁵Soft handle distribution according to Tables 3 and 4

### ¹Determination of Dielectric Constant:

The determination was carried out on the organopolysiloxanes (component (II)) in pure substance in reference to DIN EN 60247 (cf. Nihon Rufuto Co., Ltd., Liquid Dielectric Constant Meter Model 871, Operation Manual Version 1.0 2008).

The meter Model 871 of Nihon Rufuto Co. has a measuring electrode consisting of an outer and inner cylinder. The measurements were carried out at 25° C. The measurement signal is a pure sine wave with low distortion and a frequency of 10 kHz. The amplitude was 7 V rms (root mean square).

Attached to the outer cylinders, the measurement involves measuring the current flow through the liquid between the two cylinders. By using a stable voltage source and very precisely determined parameters of the measuring electrode, this signal is converted into the dielectric constant (permittivity) of the liquid.

### ²Determination of the Antibacterial Activity According to ISO 20743:

100 g of the solutions of embodiments 1 to 5 and the solution of Comparative Example 1, respectively, were each diluted with 899 g water, and 1 g acetic acid (60%) was added. After stirring, these dilutions (liquors) were applied to two textile samples (DIN A4, knitted fabric, cotton, untreated) by means of the padding method (2 bar) and dried for 2 min at 120° C. One of the two textile samples of embodiments 1 to 5 and VB1, respectively, was washed five times in accordance with DIN 26330 (40° C., detergent: IEC 60456 Base detergent Type A, phosphate free, last wash was performed without detergent. Textile was dried at room temperature).

The textile samples in the unwashed state and in the state after 5 washes were tested for their antibacterial effect in accordance with ISO 20743 with an incubation time of 24 h and referenced against the original textiles in the unfinished state to quantify the antibacterial effect of the finish. Staphylococcus aureus ATCC 6538 was used as the test germ.

The textile samples in the unwashed condition and in the condition after 5 washes were tested for their antibacterial effect in accordance with ISO 20743 with an incubation time of 24 h and referenced against the original textiles in the unfinished condition to quantify the antibacterial effect of the finish. Staphylococcus aureus ATCC 6538 was used as the test germ.

³Determination of the Absorbency of the Pure Organopolysiloxanes (Component (II)) in Accordance with AATCC 79.

1% solutions of the pure organopolysiloxanes of embodiments 1 to 5 and of Comparative Example 1 were prepared in i-propanol. These solutions were finished by the padding method on cotton (DIN A4, terry cloth, untreated) and dried at room temperature for 24 h and subsequently thermally treated at 140° C. for 1 min to remove the solvent. The pure organopolysiloxanes remained on the textile. Subsequently, a drop of water was dropped onto the textile from a defined height of 40±1.0 mm and the time until the drop sank in was measured.

⁴Determination of the Absorbency of Textiles Finished with Formulations of Embodiments 1-5 in Accordance with AATCC 79:

40 g of the formulations of embodiments 1 to 5 were diluted with 959 g water and 1 g acetic acid (60%) was added. After stirring, these dilutions (liquors) were finished on cotton (DIN A4, terry cloth, untreated) by means of the padding method (2 bar) and dried at 140° C. for 1 min. A drop of water was then dropped onto the textile from a height of 40 t 1.0 mm and the time until the drop sank in was measured.

Finishing with dimethyloctadecyl[3-(trimethoxysilyl)propyl]ammonium chloride (component (I)) at a liquor concentration of 2.25 g/L (active ingredient identical to the 40 g/L finishing of embodiments 1-5) resulted in a sink-in time of >180 sec.

⁵Assessment of the soft handle:

In order to examine the soft handle of the composition according to the present invention and to find out to what extent component (I) has an influence on the soft handle of textiles finished with the organopolysiloxanes, handle experiments were carried out with trained subjects.

The soft handle properties were classified as shown in Table 3.

TABLE 3
Soft handle classification.

| Assessment | Soft handle |
|---|---|
| Grade 1 | Soft handle unchanged compared to untreated |
| Grade 2 | Soft handle slightly improved compared to untreated |
| Grade 3 | Soft handle significantly improved compared to untreated |
| Grade 4 | Very good soft handle |

Terry textiles finished with the formulations of embodiments 1 to 5 (for details of the finishing see ⁴Determination of the absorbency of textiles finished with formulations of embodiments 1-5 in accordance with AATCC 79) and Comparative Example 1, respectively, were compared in separate series with 3 terry textiles each finished as follows:
1. Component I and V: dimethyloctadecyl[3-(trimethoxysilyl)propyl]ammonium chloride (70 wt. % in methanol, 6 g) was mixed with acetic acid (60%, 2 g) and demineralized water (92 g) by stirring until a clear solution was obtained. 40 g of this solution were diluted with 959 g water and 1 g acetic acid (60%) was added. After stirring, these dilutions (liquors) were finished by the padding method (2 bar) onto a textile sample (DIN A4, terry cloth, cotton, untreated) and dried at 140° C. for 2 min.
2. Component I, III and V: Dimethyloctadecyl[3-(trimethoxysilyl)propyl]ammonium chloride (70 wt. % in methanol, 6 g) was mixed with a fatty alcohol ethoxylate (8 g), acetic acid (60%, 2 g) and demineralized water (84 g) by stirring until a clear solution was obtained. 40 g of this solution was diluted with 959 g water and 1 g acetic acid (60%) was added. After stirring, these dilutions (liquors) were finished by the padding method (2 bar) onto a textile sample (DIN A4, terry cloth, cotton, untreated) and dried at 140° C. for 2 min.
3. Component II, III, IV and V: The polydimethylsiloxanes dissolved in 1,2-propylene glycol of embodiments 1 to 5 (20 g) were mixed in a beaker with a fatty alcohol ethoxylate 10 EO (8 g) and acetic acid (60%; 2 g), and demineralized water (70 g) was added in small portions within 10 min by stirring until a clear solution was obtained. 40 g of this solution was diluted with 959 g water and 1 g acetic acid (60%) was added. After stirring, these dilutions (liquors) were finished onto a textile sample (DIN A4, terry cloth, cotton, untreated) by means of the padding method (2 bar) and dried at 140° C. for 2 min.

In Table 4, the results of the soft handle evaluation tests are summarized.

TABLE 4
Soft handle data of textiles finished with AB1-5.

| | 1. | 2. | 3. | AB 1 |
|---|---|---|---|---|
| Subject 1 | 1 | 2 | 3 | 4 |
| Subject 2 | 1 | 2 | 3 | 4 |
| Subject 3 | 1 | 2 | 3 | 4 |
| Subject 4 | 1 | 2 | 4 | 3 |
| Subject 5 | 1 | 2 | 4 | 3 |
| Subject 6 | 1 | 2 | 3 | 4 |
| Subject 7 | 1 | 2 | 3 | 4 |
| Subject 8 | 1 | 2 | 3 | 4 |
| Average | 1 | 2 | 3.25 | 3.75 |
| | 1. | 2. | 3. | AB 2 |
| Subject 1 | 1 | 2 | 3 | 4 |
| Subject 2 | 2 | 1 | 3 | 4 |
| Subject 3 | 1 | 2 | 3 | 4 |
| Subject 4 | 1 | 2 | 3 | 4 |
| Subject 5 | 1 | 2 | 3 | 4 |
| Subject 6 | 1 | 2 | 3 | 4 |
| Subject 7 | 1 | 2 | 3 | 4 |
| Subject 8 | 1 | 2 | 4 | 3 |
| Average | 1.125 | 1.875 | 3.125 | 3.875 |
| | 1. | 2. | 3. | AB 3 |
| Subject 1 | 1 | 2 | 4 | 3 |
| Subject 2 | 1 | 2 | 3 | 4 |
| Subject 3 | 1 | 2 | 4 | 3 |
| Subject 4 | 1 | 2 | 4 | 3 |
| Subject 5 | 1 | 2 | 3 | 4 |
| Subject 6 | 1 | 2 | 4 | 3 |
| Subject 7 | 1 | 2 | 4 | 3 |
| Subject 8 | 1 | 2 | 3 | 4 |
| Average | 1 | 2 | 3.625 | 3.375 |
| | 1. | 2. | 3. | AB 4 |
| Subject 1 | 1 | 2 | 3 | 4 |
| Subject 2 | 1 | 2 | 4 | 3 |
| Subject 3 | 1 | 2 | 3 | 4 |
| Subject 4 | 1 | 2 | 4 | 3 |
| Subject 5 | 1 | 2 | 3 | 4 |
| Subject 6 | 1 | 2 | 4 | 3 |
| Subject 7 | 1 | 2 | 3 | 4 |
| Subject 8 | 1 | 2 | 4 | 3 |
| Average | 1 | 2 | 3.5 | 3.5 |
| | 1. | 2. | 3. | AB 5 |
| Subject 1 | 1 | 2 | 3 | 4 |
| Subject 2 | 1 | 2 | 3 | 4 |
| Subject 3 | 1 | 2 | 3 | 4 |
| Subject 4 | 1 | 2 | 3 | 4 |
| Subject 5 | 1 | 2 | 4 | 3 |
| Subject 6 | 1 | 2 | 4 | 3 |
| Subject 7 | 1 | 2 | 3 | 4 |
| Subject 8 | 1 | 2 | 4 | 3 |
| Average | 1 | 2 | 3.375 | 3.625 |

Textiles finished with the composition according to Comparative Example 1 showed a soft handle of 4 in the above test.

### Discussion:

In Table 2, the results of the measurement of the antibacterial activity, the measurement of the dielectric constant, the absorbency (defined as sink-in time), and the soft handle are summarized.

For all textiles finished with embodiments 1-5, average values of 3.1 to 3.9 could be obtained in the handle experiments. These textiles thus exhibit a significant improvement in soft handle compared to the untreated textile. By measuring the antibacterial activity in accordance with ISO 20743, it could be shown that the organopolysiloxanes (component (II)) of embodiments 1 to 5 show very good antibacterial activities against Staphylococcus aureus with a measured dielectric constant of 3.05 to 5.73 and an absorbency of ≤3 sec, and these do not significantly decrease or even increase after 5 washes.

Surprisingly, the antibacterial activity of the organopolysiloxane of Comparative Example 1 with a dielectric constant of 2.86 and a sink-in time >300 sec was found to have a significant loss from 3.86 to 0.71 after 5 washes.

The following items are comprised by the scope of the present invention:

1. A composition comprising
(I) at least one quaternary ammonium silane represented by the following formula (1)

X₄₋ₙSi(—R—NR¹R²R³)ₙ⁺Y⁻ Formula (1)

wherein

X is independently an alkoxy residue having 1 to 6 carbon atoms, an alkoxyalkoxy residue having 2 to 8 carbon atoms, or an alkyl residue having 1 to 6 carbon atoms,

Y⁻ is an acid anion

n is an integer selected from 1, 2 or 3,

R is a divalent hydrocarbon residue having 1 to 6 carbon atoms,

R¹ is a saturated or unsaturated, linear or branched hydrocarbon residue having 8 to 22 carbon atoms,

R² is a saturated or unsaturated, linear or branched hydrocarbon residue having 1 to 22 carbon atoms,

R³ is a saturated or unsaturated, linear or branched hydrocarbon residue having 1 to 22 carbon atoms;
(II) an organopolysiloxane compound having at least one functional group selected from a quaternary ammonium group, an amino group, an amido group and a polyalkylene oxide group,
   wherein the dielectric constant of the component (II) is 2.90-10.0 as measured at 25° C. and 10 kHz;
(III) optionally an emulsifier;
(IV) water; and
(V) optionally an organic solvent.

2. The composition according to item 1, wherein X is an alkoxy residue having 1 to 6 carbon atoms, preferably selected from methoxy, ethoxy, especially methoxy.

3. The composition according to any one of the preceding items, wherein n is an integer selected from 1 or 2, preferably 1.

4. The composition according to any one of the preceding items, wherein R is a divalent alkyl group having 1 to 6 carbon atoms, preferably selected from ethyl or propyl, more preferably propyl.

5. The composition according to any one of the preceding items, wherein R¹ is an alkyl residue having 8 to 22 carbon atoms, preferably selected from dodecyl, tetradecyl, hexadecyl or octadecyl, particularly preferably tetradecyl, hexadecyl or octadecyl.

6. The composition according to any one of the preceding items, wherein R² is an alkyl residue with 1 to 22 carbon atoms, in particular 1-10 carbon atoms, preferably methyl or ethyl, particularly preferably methyl.

7. The composition according to any one of the preceding items, wherein R³ is an alkyl residue with 1 to 22 carbon atoms, in particular 1-10 carbon atoms, preferably methyl or ethyl, particularly preferably methyl.

8. The composition according to any one of the preceding items, wherein Y⁻ is selected from chloride, bromide, iodide, methosulfate or tosylate.

9. The composition according to any one of the preceding items, wherein the content of component (I) is 1-25 wt. %, preferably 1-15 wt. %, particularly preferably 1-10 wt. %, based on the total weight of the composition.

10. The composition according to any one of the preceding items, wherein component (I) has an antimicrobial and/or antiviral effect.

11. The composition according to any one of the preceding items, wherein the content of component (II) is 1-50 wt. %, preferably 5-30 wt. %, particularly preferably 10-20 wt. %, based on the total weight of the composition.

12. The composition according to any one of the preceding items, wherein component (II) is a polydimethylsiloxane having at least one functional group selected from a quaternary ammonium group, an amino group, an amido group and a polyalkylene oxide group.

13. The composition according to any one of the preceding items, wherein the content of the polyalkylene oxide group in component (II) is 0-60 wt. %, preferably 0-40 wt. %, particularly preferably 0-20 wt. %, based on the total weight of component (II).

14. The composition according to any one of the preceding items, wherein the dielectric constant of component (II) is 2.90-6.50, more preferably 2.90-5.00, in particular 3.00-5.80, measured at 25° C. and 10 kHz.

15. The composition according to any one of the preceding items, wherein component (II) has a molecular weight of 500-50000 g/mol, preferably 1000-20000, more preferably 1500-10000 g/mol.

16. the composition according to anyone of the preceding items, wherein component (II) in the absorbency test in accordance with AATCC 79 causes a sink-in time on cotton of 0.1-30 sec, preferably 0.1-10 sec, particularly preferably 0.1-3 sec.

17. The composition according to any one of the preceding items, wherein component (II) comprises at least one quaternary ammonium group and/or at least one amino group, such as at least one primary, secondary or tertiary amino group.

18. The composition according to any one of the preceding items, wherein component (II) has at least one quaternary ammonium group, at least one quaternary ammonium and polyalkylene oxide group, at least one amino and polyalkylene oxide group, at least one quaternary ammonium, amino and polyalkylene oxide group, at least one amino and amido group, at least one amino, amido, and polyalkylene oxide group, or at least one quaternary ammonium, amino, amido, and polyalkylene oxide group.

19. The composition according to any one of the preceding items, wherein component (II) has a nitrogen content of 0.05-2 wt. %, preferably 0.10-1.5 wt. %, particularly preferably 0.10-1.0 wt. %, including any amino, amido and ammonium groups that may optionally be present.

20. The composition according to any one of the preceding items, wherein component (II) is a soft handle agent.

21. The composition according to any one of the preceding items, wherein a weight ratio of component (I) to component (II) in the composition is 1:50 to 25:1, preferably 1:30 to 3:1, more preferably 1:20 to 1:1.

22. The composition according to any one of the preceding items, wherein component (III) comprises a cationic, amphoteric or non-ionic emulsifier.

23. The composition according to any one of the preceding items, wherein component (III) comprises a quaternary ammonium salt, preferably di-(C₁₀-C₂₄)-alkyldimethylammonium chloride, (C₁₀-C₂₄)-alkyldimethylethylammonium chloride or- bromide, (C₁₀-C₂₄)-alkyltrimethylammonium chloride or -bromide, (C₁₀-C₂₄)-alkyldimethylbenzylammonium chloride, N—(C₁₀-C₁₈)-alkylpyridinium chloride or -bromide, N—(C₁₂-C₁₈)-isoquinolinium chloride, -bromide or -monoalkylsulfate, N—(C₁₂-C₁₈)-alkyl-N-methyl-ammounium-morpholinium-chloride, -bromide or -monoalkyl sulfate, N—(C₁₂-C₁₈)-alkyl-N-ethyl-ammounium morpholinium chloride, -bromide or -monoalkyl sulfate, N—(C₁₂-C₁₈)-alkylmethyl polyoxyethylene ammonium chloride,-bromide or -monoalkyl sulfate, a salt of a primary, secondary or tertiary fatty amine having 8 to 24 carbon atoms, with an organic acid such as acetic acid, lactic acid, glycolic acid or citric acid, or an inorganic acid such as hydrochloric acid, sulfuric acid and phosphoric acid, or a mixture thereof.

24. The composition according to any one of the preceding items, wherein component (III) comprises an alkoxylation product, in particular an ethoxylate or propoxylate, of an aliphatic alcohol having 6 to 22 carbon atoms, in particular a branched aliphatic alcohol, preferably an ethoxylate of 2,6,8-trimethyl-4-nonanol, isodecyl alcohol or isotridecyl alcohol having an ethylene oxide content of from 2 to 50 moles, in particular from 3 to 15 moles.

25. The composition according to any one of the preceding items, wherein the content of component (III) is 0-20 wt. %, preferably 1-15 wt. %, particularly preferably 2-10 wt. %, based on the total weight of the composition.

26. The composition according to any one of the preceding items, wherein the content of component (V) is 0-20 wt. %, preferably 1-10 wt. %, particularly preferably 2-6 wt. %, based on the total weight of the composition.

27. The composition according to any one of the preceding items, wherein component (V) comprises a monofunctional or polyfunctional alcohol having 2-10 carbon atoms, in particular methanol, ethanol, isopropanol and/or a dialcohol, an alkyl ether, in particular a mono- or dialkyl ether, or alkyl esters, in particular a mono- or diester, thereof, or a mixture thereof.

28. The composition according to any one of the preceding items, wherein component (V) comprises butyldiglycol, 1,2-propylene glycol, dipropylene glycol, dipropylene glycol monomethyl ether, dipropylene glycol monobutyl ether, tripropylene glycol monobutyl ether, or a mixture thereof.

29. The composition according to any one of the preceding items, wherein the composition further comprises: (VI) a mono- or poly-functional carboxylic acid having 1-5 carbon atoms.

30. The composition according to item 29, wherein component (VI) is selected from formic acid, acetic acid, propanoic acid, butanoic acid, pentanoic acid, lactic acid, citric acid, maleic acid, fumaric acid, succinic acid, pyruvic acid, polyhydroxycarboxylic acids, and mixtures thereof.

31. The composition according to any one of items 29-30, wherein the content of component (VI) is 0-10 wt. %, preferably 0.5-5 wt. %, particularly preferably 1-5 wt. %, based on the total weight of the composition.

32. The composition according to any one of the preceding items, wherein the content of water is 0-98 wt. %, preferably 25-92.5 wt. %, particularly preferably 49-84 wt. %, based on the total weight of the composition.

33. Use of the composition according to any one of items 1-32 for finishing a textile.

34. The use according to claim 33 for the antimicrobial finishing of the textile.

35. A method of finishing a textile, comprising.

applying the composition according to any one of items 1-32 to a textile, and
optionally drying the textile that has been treated in this way.

36. The method according to item 35, wherein the composition is applied in an amount of 0.2-5 dry wt. % of components (I), (II) and optionally (III) based on the weight of the textile.

37. The method according to any one of items 35-36, wherein the drying is carried out at a temperature of 80-150° C.

38. A product obtained by a method according to anyone of items 35-37.

39. A method for preparing a composition according to any one of items 1-32, comprising

a) mixing components (I), (II), optionally (III), optionally (V) and optionally (VI), and

(b) optionally adding (IV) water to the mixture obtained in step (a).

1. A composition comprising
(I) at least one quaternary ammonium silane represented by the following formula (1)
X₄₋ₙSi(—R—NR¹R²R³)ₙ⁺Y⁻ Formula (1)
wherein
X is independently an alkoxy residue having 1 to 6 carbon atoms, an alkoxyalkoxy residue having 2 to 8 carbon atoms, or an alkyl residue having 1 to 6 carbon atoms,
Y⁻ is an acid anion
n is an integer selected from 1, 2 or 3,
R is a divalent hydrocarbon residue having 1 to 6 carbon atoms,
R¹ is a saturated or unsaturated, linear or branched hydrocarbon residue having 8 to 22 carbon atoms,
R² is a saturated or unsaturated, linear or branched hydrocarbon residue having 1 to 22 carbon atoms,
R³ is a saturated or unsaturated, linear or branched hydrocarbon residue having 1 to 22 carbon atoms;
(II) an organopolysiloxane compound having at least one functional group selected from a quaternary ammonium group, an amino group, an amido group and a polyalkylene oxide group,
wherein the dielectric constant of the component (II) is 2.90-10.0 as measured at 25° C. and 10 kHz;
(III) optionally an emulsifier;
(IV) water; and
(V) optionally an organic solvent.

2. The composition according to claim 1, wherein X is an alkoxy residue having from 1 to 6 carbon atoms, preferably selected from methoxy or ethoxy, and/or
wherein R is a divalent alkyl group having 1 to 6 carbon atoms, preferably selected from ethyl or propyl, and/or
wherein R¹ is an alkyl residue having 8 to 22 carbon atoms, preferably selected from dodecyl, tetradecyl, hexadecyl or octadecyl, and/or
wherein R² is an alkyl residue having 1 to 22 carbon atoms, preferably methyl or ethyl, and/or
wherein R³ is an alkyl residue having 1 to 22 carbon atoms, preferably methyl or ethyl, and/or
wherein Y⁻ is selected from chloride, bromide, iodide, methosulfate or tosylate.

3. The composition according to claim 1, wherein the content of component (I) is 1-25 wt. %, preferably 1-15 wt. %, particularly preferably 1-10 wt. %, based on the total weight of the composition, and/or
wherein the content of component (II) is 1-50 wt. %, preferably 5-30 wt. %, particularly preferably 10-20 wt. %, based on the total weight of the composition, and/or
wherein the content of water is up to 98 wt. %, preferably 25-92.5 wt. %, particularly preferably 49-84 wt. %, based on the total weight of the composition.

4. The composition according to claim 1, wherein component (II) is a polydimethylsiloxane having at least one functional group selected from a quaternary ammonium group, an amino group, an amido group and a polyalkylene oxide group.

5. The composition according to claim 1, wherein the dielectric constant of component (II) is 2.90-6.50, more preferably 2.90-5.00, in particular 3.00-5.80, measured at 25° C. and 10 kHz.

6. The composition according to claim 1, wherein component (II) has a molecular weight of 500-50000 g/mol, preferably 1000-20000, more preferably 1500-10000 g/mol.

7. The composition according to claim 1, wherein component (II) has at least one quaternary ammonium group, at least one quaternary ammonium and polyalkylene oxide group, at least one amino and polyalkylene oxide group, at least one quaternary ammonium, amino and polyalkylene oxide group, at least one amino and amido group, at least one amino, amido, and polyalkylene oxide group, or at least one quaternary ammonium, amino, amido, and polyalkylene oxide group.

8. The composition according to claim 1, wherein component (III) comprises a quaternary ammonium salt, preferably di-(C₁₀-C₂₄)-alkyldimethylammonium chloride, (C₁₀-C₂₄)-alkyldimethylethylammonium chloride or- bromide, (C₁₀-C₂₄)-alkyltrimethylammonium chloride or -bromide, (C₁₀-C₂₄)-alkyldimethylbenzylammonium chloride, N—(C₁₀-C₁₈)-alkylpyridinium chloride or -bromide, N—(C₁₂-C₁₈)-isoquinolinium chloride, -bromide or -monoalkylsulfate, N—(C₁₂-C₁₈)-alkyl-N-methyl-ammounium-morpholinium-chloride, -bromide or -monoalkyl sulfate, N—(C₁₂-C₁₈)-alkyl-N-ethyl-ammounium morpholinium chloride, -bromide or -monoalkyl sulfate, N—(C₁₂-C₁₈)-alkylmethyl polyoxyethylene ammonium chloride,-bromide or -monoalkyl sulfate, a salt of a primary, secondary or tertiary fatty amine having 8 to 24 carbon atoms, with an organic acid such as acetic acid, lactic acid, glycolic acid or citric acid, or an inorganic acid such as hydrochloric acid, sulfuric acid and phosphoric acid, or a mixture thereof.

9. The composition according to claim 1, wherein component (III) comprises an alkoxylation product, in particular an ethoxylate or propoxylate, of an aliphatic alcohol having 6 to 22 carbon atoms, in particular a branched aliphatic alcohol, preferably an ethoxylate of 2,6,8-trimethyl-4-nonanol, isodecyl alcohol or isotridecyl alcohol having an ethylene oxide content of from 2 to 50 moles, in particular from 3 to 15 moles.

10. The composition according to claim 1, wherein component (V) comprises butyldiglycol, 1,2-propylene glycol, dipropylene glycol, dipropylene glycol monomethyl ether, dipropylene glycol monobutyl ether, tripropylene glycol monobutyl ether, or a mixture thereof.

11. The composition according to claim 1, wherein the composition further comprises:
(VI) a mono- or poly-functional carboxylic acid having 1-5 carbon atoms,
wherein component (VI) is preferably selected from formic acid, acetic acid, propanoic acid, butanoic acid, pentanoic acid, lactic acid, citric acid, maleic acid, fumaric acid, succinic acid, pyruvic acid, polyhydroxycarboxylic acids, and mixtures thereof.

12. Use of the composition according to claim 1 for finishing a textile.

13. A method of finishing a textile, comprising.
applying the composition according to claim 1 to a textile, and
optionally drying the textile that has been treated in this way,
wherein the composition is applied in an amount of 0.2-5 dry wt. % of components (I), (II) and optionally (III) based on the weight of the textile.

14. A product obtained by the method according to claim 13.

15. A method for preparing a composition according to claim 1, comprising
(a) mixing components (I), (II), optionally (III), optionally (V) and optionally (VI), and
(b) optionally adding (IV) water to the mixture obtained in step (a).
